(19) United States
(12) Patent Application Publication
(10) Pub. No.: US 2016/0087480 A1
(43) Pub. Date: Mar. 24, 2016

(54) Charging Apparatus Including Remote Device Reset

(71) Applicant: QUALCOMM Incorporated, San Diego, CA (US)

(72) Inventors: Colby TRUDEAU, Carlsbad, CA (US); Zhen Ning Low, San Diego, CA (US)

(21) Appl. No.: 14/493,432

(22) Filed: Sep. 23, 2014

(51) Int. Cl. H02J 7/02; H02J 7/00

(52) U.S. Cl. CPC H02J 7/025; H02J 7/0044

(57) ABSTRACT

A rechargeable computing device including a battery, a processor, a power receiver, a reset switch, and a circuit for receiving a reset signal may receive the reset signal via a power source. The processor may be configured to be reset in response to actuation of the reset switch. The power receiver may be configured to receive a wireless power transmission from a remote charging apparatus and charge the battery using power captured from the wireless power transmission. The reset switch may be coupled to the processor and to the circuit for receiving a reset signal. The circuit for receiving a reset signal may be configured to activate the reset switch to reset the processor in response to detecting a reset signal encoded within a wireless power transmission. In some embodiments, the circuit for receiving a reset signal may be configured to receive the signal from a wired power input.

### BACKGROUND

Most sophisticated mobile computing devices that operate using an onboard processor, such as smart watches, cell phones, and tablet computers, experience circumstances in which they become unresponsive, such as due to a software bug or an invalid input. Such mobile computing devices generally include a dedicated reset button for recovering from various system failures. When depressed, the reset button may activate a hardware reset option on a processor, such as interrupting power or triggering a reboot. Typically reset buttons are positioned directly on the outer casing, often positioned behind a pinhole. Alternatively, a reset capability may be a hardware-reset switch that is activated by holding down one or more physical buttons of the device for a period of time. However, reset buttons are seldom used, add costs and compromise the waterproofing of the computing device.

### SUMMARY

The various embodiments provide a reset capability implemented through a charging mechanism for rechargeable computing devices that does not require a physical reset button to be included on the device's case. Some embodiments include a rechargeable computing device including a battery, a processor, a power receiver, a reset switch, and a programmable logic circuit. The processor may be powered by the battery and configured to control operations of the rechargeable computing device. The power receiver may be coupled to the battery and configured to receive a wireless power transmission from a remote charging apparatus and charge the battery using power captured from the wireless power transmission. The programmable logic circuit may be coupled to the power receiver and the reset switch, and configured to activate the reset switch to reset the processor in response to detecting a reset signal encoded within the wireless power transmission.

Some embodiments include a wireless signal receiver coupling the power receiver to the programmable logic circuit. The wireless signal receiver may be configured to detect the reset signal using at least one of amplitude or frequency modulation of the wireless power transmission. The programmable logic circuit may be configured to recognize the reset signal as a coded sequence in the wireless power transmission. The programmable logic circuit may be configured to operate independent of the processor. The programmable logic circuit may be independently powered by the battery.

Some embodiments include a system including a remote charging apparatus and a rechargeable computing device. The remote charging apparatus may include a charger housing, a power transmitter and a reset input element. The power transmitter may be disposed within the charger housing. The power transmitter may be configured to receive a power input from a power source and output a wireless power transmission. The reset input element may be connected to the power transmitter and configured to encode a reset signal in the wireless power transmission in response to receiving a user input. The remote charging apparatus may further include a wireless signal transmitter configured to encode the reset signal in the wireless power transmission. The remote charging apparatus may further include a power plug configured to receive the power input from the power source and convey power to the power transmitter. The remote charging apparatus may further include a power converter for transforming DC current from the DC power supply into an AC current provided to the power transmitter.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a schematic diagram of a rechargeable computing device with a wireless charger for remote reset according to various embodiments of the disclosure.

FIG. 2 is a perspective view of rechargeable computing devices on a wireless charger for remote reset according to various embodiments of the disclosure.

FIG. 3 is a schematic diagram of a rechargeable computing device with a wireless charger for remote reset according to various embodiments of the disclosure.

FIG. 4 is a side view of an embodiment rechargeable computing device including a schematic diagram of a wireless charger for remote reset according to various embodiments of the disclosure.

FIG. 5 is a schematic diagram of a rechargeable computing device with a wired charger for remote reset according to various embodiments of the disclosure.

FIG. 6 is a schematic diagram of a rechargeable computing device with a wired charger for remote reset according to various embodiments of the disclosure.

FIG. 7 is a perspective view of a rechargeable computing device with a wired charger for remote reset according to various embodiments of the disclosure.

FIG. 8 is a schematic diagram of a rechargeable computing device with a DC powered wired charger for remote reset according to various embodiments of the disclosure.

FIG. 9 is a schematic diagram of a rechargeable computing device with a DC powered wired charger for remote reset according to various embodiments of the disclosure.

FIG. 10 is a perspective view of a rechargeable computing device with a DC powered wired charger for remote reset according to various embodiments of the disclosure.

FIG. 11 is a schematic diagram of a rechargeable computing device with a DC powered wireless charger for remote reset according to various embodiments of the disclosure.

FIG. 12 is a process flow diagram illustrating an embodiment method for transmitting output power for charging and/or resetting a rechargeable computing device according to various embodiments of the disclosure.

FIG. 13 is a process flow diagram illustrating an embodiment method for transmitting output power for charging and/or resetting a rechargeable computing device according to various embodiments of the disclosure.

FIG. 14 is a process flow diagram illustrating another embodiment method for receiving input power for charging and/or resetting a rechargeable computing device according to various embodiments of the disclosure.

FIG. 15 is a schematic component diagram illustrating a rechargeable computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Various embodiments include a rechargeable computing device configured to receive, via a remote charging apparatus, a reset signal for resetting a processor controlling operations of the rechargeable computing device. A power receiver of the rechargeable computing device may be configured to receive a power transmission from the remote charging apparatus for charging an onboard battery. The reset signal may be transmitted in-band within the power transmission. A programmable logic circuit coupled to the power receiver may detect the reset signal and in response thereto activate a reset switch for resetting a processor of the rechargeable computing device.

Various embodiments include the remote charging apparatus for conveying the power transmission to the power receiver. The remote charging apparatus may include a reset input element, such as a button, for receiving a reset input used to trigger the reset of the processor of the rechargeable computing device. In response to receiving the reset input, the power transmission may be altered to include the reset signal in-band with the power transmission for resetting the processor.

The word “exemplary” is used herein to mean “serving as an example, instance, or illustration.” Any implementation described herein as “exemplary” is not necessarily to be construed as preferred or advantageous over other implementations.

The term “rechargeable computing device” is used herein to refer to any electrical appliance that uses and draws current from an onboard battery that may be refilled with electrical power. The rechargeable computing device may be any electrical device from a small consumer electronic device to a large-scale commercial appliance. For example, the rechargeable computing device may refer to any one or all of cellular telephones, smart phones, programmable watch, smart watch, hearing aid, personal electronic exercise gear, waterproof electronics, laptop computers, tablet computers, smart books, palm-top computers, personal or mobile multi-media players, personal data assistants (PDA's), wireless electronic mail receivers, streaming media players, digital media players, and similar electronic devices that include an onboard battery. Various embodiments may be suitable for a variety of devices, such as small electronic devices that do not have room on an external housing for a separate reset button or electronic devices that need to maintain a waterproof seal.

The term “onboard battery” is used herein to refer to a supply or source of electric energy that is carried within or integrated as part of a rechargeable computing device. The onboard battery may be recharged to replenish expended, depleted, and/or reduced electric energy stored therein.

The term “power receiver” is used herein to refer to a component of the rechargeable computing device configured to receive a power transmission from a remote charging apparatus. The power receiver may be coupled to the onboard battery for charging the onboard battery using the received power transmission.

The term “wireless power transmission” is used herein to refer to the transmission of electrical energy from a power source to an electrical load or storage device without wired conductors. For example, wireless power transmission may be achieved by induction, which may transfer (without contact) electro-magnetic energy to a receptive electrical device in close proximity. Using induction, energy may be sent through an inductive coupling from a remote charging apparatus to an electrical device, which may then use that energy to run the electrical device or charge batteries. A primary induction coil may be used to create an alternating electromagnetic wave from within the remote charging apparatus, and a secondary induction coil in the electrical device takes power from the electromagnetic wave and converts it back into electrical current. The primary induction coil and secondary induction coil in close proximity to one another combine to form an electrical transformer. Greater distances between primary and secondary coils may be achieved when the inductive transfer uses resonant inductive coupling.

The term “reset switch” is used herein to refer to a component that is carried within or integrated as part of a computing device, such as a rechargeable computing device. Activation of the reset switch will reset a processor of the computing device, by resetting the registers and peripherals of the computing device to a predetermined state. The reset switch may be activated by a dedicated button or dedicated user input for resetting the electrical device, which may be prone to freezing or locking up. In accordance with various embodiments, unlike the reset switch that may be part of the computing device, the dedicated button or interface for receiving the dedicated user input may be remote from the computing device.

The terms “programmable logic circuit” is used herein to refer to a computational circuit element for controlling a process or other circuit element, such as a switch or a processor. The programmable logic circuit may be a programmable logic controller, which controls a particular function, such as a reset of the computing device. The programmable logic circuit may be designed to receive analog and/or digital inputs and convert such inputs into a corresponding predetermined output.

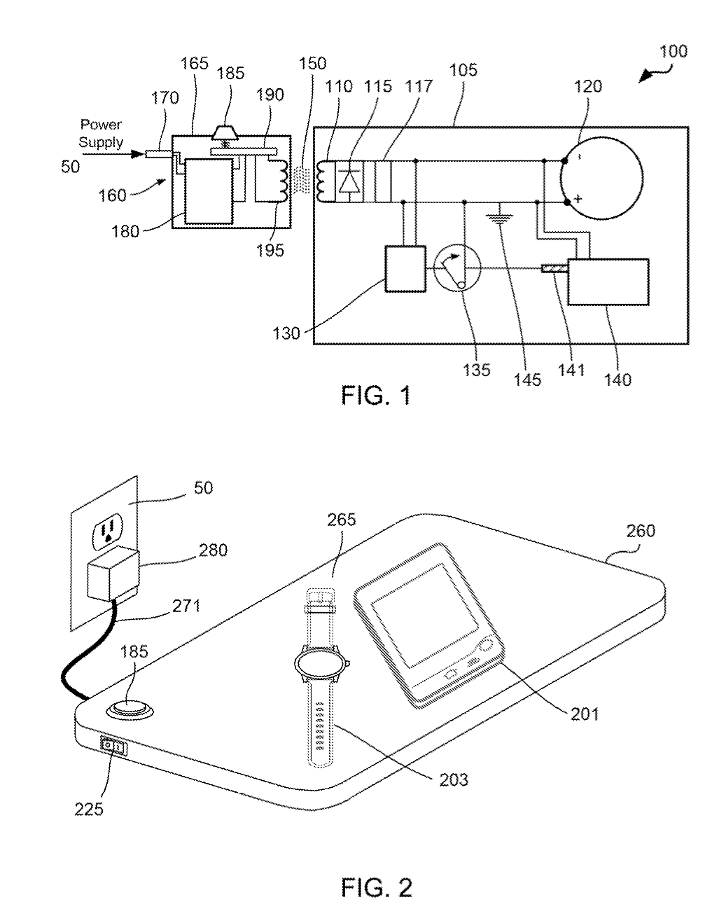

FIG. 1 illustrates a schematic circuit diagram of a rechargeable computing device 100 with remote reset according to various embodiments. The rechargeable computing device 100 may include a housing 105 that contains and/or holds various components, including a power receiver 110, an onboard battery 120, a programmable logic circuit 130, a reset switch 135, and a processor 140. The rechargeable computing device 100 may be configured to receive power for charging the onboard battery 120 from a remote charging apparatus 160. The remote charging apparatus 160 may supply power using a wireless power transmission 150. The remote charging apparatus 160 may convert an alternating current (AC) supply 50 into a wireless power transmission 150. The wireless power transmission 150 may be formed from an electromagnetic wave generated by a wireless power transmitter 195, such as a primary induction coil. The power receiver 110, in the rechargeable computing device 100, may include a secondary induction coil that takes power from the wireless power transmission 150 and converts that power back into AC. In this way, the primary induction coil and the secondary induction coil in proximity combine to operate like an electrical transformer. The power receiver 110 will spontaneously generate AC when maintained in the electromagnetic wave of the wireless power transmission 150. That onboard current may be used for charging or running the rechargeable computing device 100. The term “charging” as used herein includes both supplying an initial charge as well as replenishing a charge (i.e., recharging).

The rechargeable computing device 100 may be any electronic appliance that includes at least one processor (i.e., processor 140), that may benefit from at least occasionally being reset. In addition, various embodiments are well suited to a rechargeable computing device 100 with a processor 140 that is remotely resettable. For example, small electronic appliances do not have a lot of space to include a separate dedicated reset button and may benefit from a remote reset feature. Similarly, waterproof or other electronic appliances that need to maintain a seal may have that seal compromised by and externally accessible reset button.

In various embodiments, the rechargeable computing device 100 includes remote reset functionality that enables a remote reset of the processor 140 to be initiated from the remote charging apparatus 160. The remote charging apparatus 160 may be configured to receive a reset input, such as from a reset button 185, used to trigger a remote reset of the processor 140 of the rechargeable computing device 100. In response to receiving the reset input, the remote charging apparatus 160 may be configured to encode a reset signal within the wireless power transmission 150, such as through in-band modulation. The power receiver 110 of the rechargeable computing device 100 may be configured to receive the wireless power transmission 150 from the remote charging apparatus 160. In addition, the power receiver 110 may be coupled to the onboard battery for charging the onboard battery using the wireless power transmission. The power receiver 110 may act like an antenna to receive the encoded reset signal as part of receiving the wireless power transmission 150, which may be detected by the programmable logic circuit 130. In response to detecting the reset signal, the programmable logic circuit 130 may activate the reset switch 135 to reset the processor 140. The power receiver 110 is an example of a means for receiving power. The reset switch 135 is an example of a means for resetting the means for controlling operations.

Wireless power transmissions may be similar to radio signal transmissions in that they both use electromagnetic waves. Unlike wireless power transmissions, in radio signal transmissions the proportion of energy received relative to transmitted energy only becomes critical if it is too low for the signal to be distinguished from the background noise. Efficiency is the more desirable parameter in wireless power transmission, so wireless power transmission generally attempts to maximize the proportion of energy received relative to energy transmitted. Nonetheless, the higher efficiency of energy transfer in wireless power transmission need not preclude control signals from being encoded within the wireless power transmission. The electromagnetic waves forming the wireless power transmission 150 may be augmented to include a detectable pattern that defines the reset signal. In this way, the reset signal may be transmitted in-band within the electromagnetic waves forming the wireless power transmission 150.

The alternating current generated by the power receiver 110 may be demodulated in order to detect and extract the reset signal carried therein. In various embodiments a reset signal may be encoded in the wireless power transmission 150 may be detectable in the AC current generated in the power receiver in the form of amplitude variations (amplitude modulation), frequency variations (frequency modulations), combinations of amplitude and frequency variations (phase plus amplitude modulation), and on-off variations (continuity modulation) similar to Morse Code. The programmable logic circuit 130 of the rechargeable computing device 100 may be programmed to detect the reset signal when present within the wireless power transmission 150, and in response thereto activate a reset of the processor 140. For example, the programmable logic circuit 130 may detect a predetermined coded sequence transmitted in-band within the wireless power transmission 150. The predetermined coded sequence may be simple (e.g., a pilot signal with bits of data). However, in order to avoid inadvertently resetting the processor 140, the predetermined coded sequences may be complex enough to not be easily generated by accident or unintentionally. In contrast, a more complex signal, such as a CDMA code, may require a more sophisticated processor to be detected.

The programmable logic circuit 130 may be a decoding circuit able to operate separate from the processor 140. In this way, if the processor 140 becomes unresponsive, the programmable logic circuit 130 may still work to trigger the remote reset functionality. In addition, the programmable logic circuit 130 may be powered independent of the onboard battery 120. For example, the wireless power transmission 150, potentially carrying the reset signal, may also power the programmable logic circuit 130. Alternatively or additionally, a separate back-up battery (not shown) may power the programmable logic circuit 130. The programmable logic circuit 130 is an example of a means for detecting a reset signal encoded within the wireless power transmission.

The programmable logic circuit 130 may be electronically coupled to the power receiver 110 in various configurations. In some embodiments, a rectifier 115 and/or a regulator 117 may be coupled between the power receiver 110 and other components of the rechargeable computing device 100, such as the onboard battery 120 or the programmable logic circuit 130. Since the power receiver 110 generates AC current from the wireless power transmission 150, the rectifier 115 may convert the AC current to direct current (DC) suitable for charging the battery. The regulator 117 may control the voltage level fed to the onboard battery 120, the processor 140, and other components. The rectifier 115 and/or the regulator 117 may be separate circuit components or integrally formed with the power receiver 110 or other component(s) of the rechargeable computing device 100.

In addition to using the DC current from the rectifier 115 to charge directly the onboard battery 120, the reset signal may be detectable therein if included in the wireless power transmission 150. Variations in the onboard DC current, such as variations in voltage, amplitude, and/or continuity (i.e., an on/off sequence) therein originating from the wireless power transmission 150 may be used to carry a control signal, such as the reset signal. If necessary, additional electronic filters or other components may be included to demodulate, detect and/or isolate the reset signal.

The onboard battery 120 may include positive and negative terminals for receiving current from the power receiver 110 and discharging current to the processor 140 and other components of the rechargeable computing device 100. The onboard battery 120 may be any form of rechargeable battery cell or cells, or a fuel cell, which may be discharged and recharged repeatedly. The onboard battery 120 may be implemented as a standalone unitary device sized and configured to be loaded or plugged into the rechargeable computing device 100. In this way, the onboard battery 120 may be integrated as a permanent component of the rechargeable computing device 100 or designed as a removable and/or replaceable element.

The onboard battery 120 may include one or more energy storage cells, such as electrochemical cells that convert stored chemical energy into electrical energy (e.g., lithium ion, nickel metal hydride, nickel cadmium, or lead-acid battery cells). Each cell may contain a cathode coupled to the positive terminal (“+”) and an anode coupled to the negative terminal (“−”). When the rechargeable computing device 100, including any individual components thereof, draws power from the onboard battery 120, ions may move between the electrodes (i.e., the cathode and the anode) via the two terminals +, −, which allows current to flow out of the onboard battery 120 to supply energy to the rechargeable computing device 100. In addition, the onboard battery 120 is rechargeable. In this way, the onboard battery 120 may be configured to receive the power transmission from the remote charging apparatus 160 for replenishing expended, depleted, and/or reduced electric energy stored therein. The size and/or capacity of the onboard battery 120 may be configured to suit the needs of a particular rechargeable computing device 100 for which it is designed. Thus, elements such as the delivered voltage, amperage, and current, may be customized to meet requirements for the load device.

The reset switch 135 may be a component of the rechargeable computing device 100 configured to activate a reset pin of the processor 140. The reset switch 135 may be a solid-state switch (e.g., a transistor) or an electromechanical switch with a first electrical contact connected (i.e., electronically coupled) to a reset pin 141 of the processor 140. In addition, the reset switch 135 may include a second electrical contact connected (i.e., electronically coupled) to a conductor leading to ground 145 or another circuit element. The reset switch 135 may be in one of two states; either “closed,” meaning electricity can flow between the first and second electrical contacts, or “open,” meaning the contacts are electrically isolated from each other and the reset switch 135 is non-conducting.

A gate of the reset switch 135 may connect to (i.e., electronically coupled) the programmable logic circuit 130. In this way, the programmable logic circuit 130 may activate the reset switch 135, changing the reset switch 135 from an open to a closed state. In this way, the reset switch 135 may act as a “kill switch,” for incapacitating or resetting the processor 140. Changing the reset switch 135 to a closed state may pull the reset pin 141 hi or low for triggering a reset of the processor 140. In this way, an output from the programmable logic circuit 130 may trigger the reset switch 135 to reset the processor 140. Alternatively, an input to the reset pin 141 may turn-on a file allocation table (FAT) of the processor 140, which triggers a reboot of the system. The reset switch 135 may alternatively be an electro-optical, vacuum tube, solid-state relay, or other relay capable of opening and/or closing an electric circuit.

The processor 140 may be configured to control operations of the rechargeable computing device and may be supplied power from the onboard battery 120. The processor 140 may be any programmable microprocessor, microcomputer or multiple processor chip or chips configured by software instructions (applications) to perform a variety of functions, including the functions of the various aspects described herein. The rechargeable computing device 100 may include multiple processors, such as one processor dedicated to primary device functions and one or more processors dedicated specialized function, such as running software applications. Typically, software applications may be stored in an internal memory for access and loading into the processor 140. The internal memory may be sufficient to store data, such as the application software instructions. In addition, the internal memory may be a volatile or nonvolatile memory, such as flash memory, or a mixture of both. For the purposes of this description, a general reference to memory refers to memory accessible by a processor including permanently fixed internal memory or removable memory plugged into the rechargeable computing device 100 and memory within the processor 140. The processor 140 is an example of means for controlling operations of the rechargeable computing device.

The remote charging apparatus 160 may include a housing 165 that contains and/or holds various components, including a power plug 170, a power transformer 180, a reset input element 190, and the wireless power transmitter 195. The remote charging apparatus 160 may be configured to receive a power input from a power source, such as an AC supply 50. For example, the AC supply 50 may be a conventional electrical wall socket in a building or electrical cord providing steady power through conductive contacts. The power plug 170 may be a conductive element that allows electricity to efficiently flow from the AC supply 50 to the power transformer 180. The power transformer 180 may step-down the supply voltage, provided by the AC supply 50 to a level suitable for lower voltage circuits. In this way, the power transformer 180 generates (i.e., transforms) the AC supply 50 to a suitable output power. For example, the power transformer 180 may include a single-phase voltage transformer commonly used with small electrical appliances. The power transformer 180 may be electrically coupled to the reset input element 190 that passes the output power to the wireless power transmitter 195.

To conserve power, the remote charging apparatus 160 may include a standby power mode when idle (e.g., when it is not in proximity to a rechargeable computing device). The remote charging apparatus 160 may include a sensor for detecting when an object is placed on or in close proximity to the remote charging apparatus 160. In this way, when no object is present the remote charging apparatus 160 may operate in standby power mode. Further, the same sensor or an additional sensor may detect whether the object placed on or in close proximity to the remote charging apparatus 160 is an appropriate device for receiving a wireless power transmission. For example, a sensor may determine whether the programmable computing device includes a Qi-compliant receiver for wireless charging.

The reset input element 190 may include a signal augmentation circuit, such as a modulator, for augmenting the output power with a reset signal. In this way, before the wireless power transmitter 195 transmits the output power, the reset signal may be included in-band therein. The reset input element 190 may include a reset button 185 for receiving a reset input from a user wanting to reset the rechargeable computing device 100. The reset button 185 may include a switch that activates the signal augmentation circuits of the reset input element 190. Pressing the reset button 185 may trigger the reset input element to augment the output power, thereby encoding the reset signal therein. Otherwise, if no reset input is received (e.g., the reset button 185 is not pressed), the reset input element 190 may convey the output power as-is (i.e., without a reset signal encoded therein) to the wireless power transmitter 195. Alternatively, the reset input may be received from a different user interface or even a receiver for getting a wireless input from yet another remote source. The output power received in the reset input element 190 from the power transformer 180 may be treated like a carrier signal, which may be augmented by changing a property thereof. In this way, the amplitude, frequency, continuity, or other property of the output power may be changed to encode the predetermined coded sequence associated with the reset signal.

As described above, the wireless power transmitter 195 may include a primary induction coil, which converts the received output power to the wireless power transmission 150. In response to the reset input element 190 augmenting the output power to include the reset signal, the wireless power transmission 150 will also carry the reset signal. Otherwise, although the wireless power transmission 150 will not include the reset signal it may still be used to charge the rechargeable computing device 100.

The housings 105, 165 of the rechargeable computing device 100 and the remote charging apparatus 160 may be a rigid material intended to hold a shape and size or a more flexible material, such as a soft pouch, or some combination thereof. The housings 105, 165 generally define the outermost size and shape of the rechargeable computing device 100 and the remote charging apparatus 160, respectively, which may vary.

FIG. 2 illustrates rechargeable computing devices 201, 203 on a remote charging apparatus 260 for remote reset according to various embodiments of the disclosure. The illustrated rechargeable computing device 201 is a mobile communication device, such as a cellular telephone, while the rechargeable computing device 203 is a smart watch. The smart watch may be a computerized wristwatch with functionality that is enhanced beyond timekeeping, and may be comparable to a personal digital assistant (PDA) device and/or include mobile phone capabilities (i.e., a watch phone). One or both of the rechargeable computing devices 201, 203 may include the programmable logic circuit (e.g., 130 in FIG. 1) and remote processor reset functionality described above with regard to the rechargeable computing device (e.g., 100 in FIG. 1). The rechargeable computing devices in the various embodiments are not limited to mobile communication devices or smart watches, and may be any rechargeable electrical device with an onboard processor that may benefit from being reset.

The remote charging apparatus 260 may include the same or similar components to those described above with regard to the remote charging apparatus 160. One notable difference is that the remote charging apparatus 260 includes a separate transformer 280 external housing 265. The transformer 280 may be connected by an electrical cord 271 and includes a power plug (not shown) that is plugged into a wall receptacle providing the AC supply 50. The remote charging apparatus 260 may also include a power switch 225. The power switch 225 may include an “off” position that cuts-off (i.e., turns off) the wireless power transmission otherwise emitted by the remote charging apparatus 260. When the power switch 225 is in the “on” position, rechargeable computing devices 201, 203 placed on a broad flat region of the external housing 265 may receive the wireless power transmission. In addition, when a user presses the reset button 185, the remote charging apparatus 260 may encode a reset signal within the wireless power transmission to the rechargeable computing devices 201, 203.

The remote charging apparatus 260 (similar to remote charging apparatus 160; FIG. 1) advantageously may work with rechargeable computing devices, regardless of whether they include remote reset elements. For example, one of the two rechargeable computing devices 201, 203 may include the remote processor reset functionality described above, while the other does not. Regardless of which of the two rechargeable computing devices 201, 203 includes the remote processor reset functionality, the remote charging apparatus 260 may still charge both rechargeable computing devices 201, 203. The rechargeable computing device without remote processor reset functionality will not reset from the wireless power transmission carrying a reset signal, but it may still use the wireless power transmission for charging.

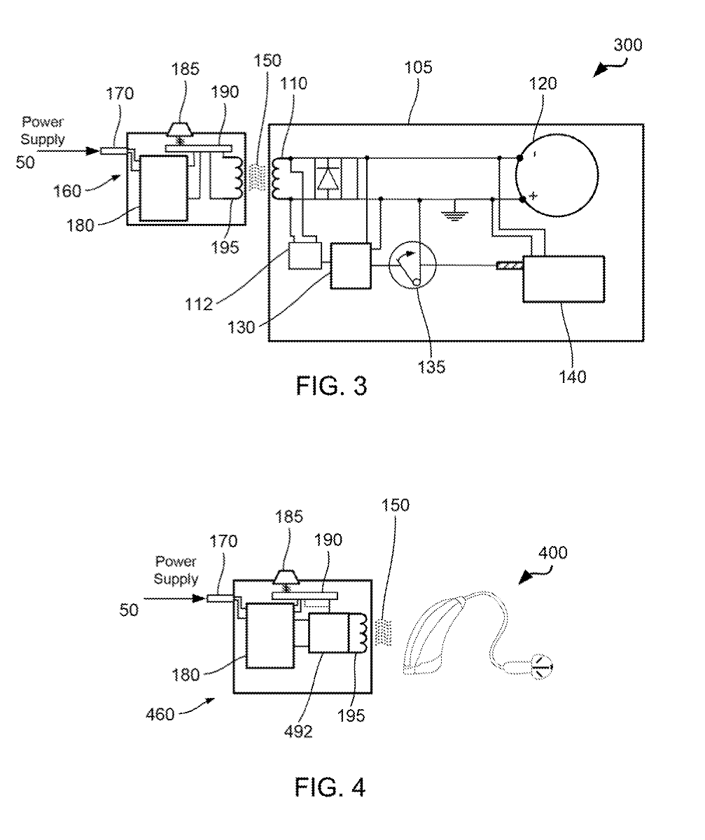

FIG. 3 illustrates an example embodiment rechargeable computing device 300. The rechargeable computing device 300 may include the remote reset functionality described above with reference to the rechargeable computing device of FIG. 1 (i.e., 100). Also, the rechargeable computing device 300 may include similar elements to the rechargeable computing device 100, such as a housing 105, a power receiver 110, an onboard battery 120, a programmable logic circuit 130, a reset switch 135, and a processor 140. Similarly, the rechargeable computing device 300 may receive the wireless power transmission 150 from the remote charging apparatus 160, which may include the power plug 170, the power transformer 180, the reset input element 190, and the wireless power transmitter 195.

In this embodiment, the rechargeable computing device 300 may include a wireless signal receiver 112 electronically coupled to leads of the induction coil of the power receiver 110. The wireless signal receiver 112 may be an electronic component that converts the signals carried by the electromagnetic waves of the wireless power transmission 150 to a form that can be interpreted by a processor, logic circuit or other circuitry. Using the power receiver 110 like an antenna, the wireless signal receiver 112 extracts information from the generated AC through demodulation and provides the information to the programmable logic circuit 130. The wireless signal receiver 112 may include filters in order to separate a particular frequency used to detect the presence of the reset signal in the wireless power transmission 150. An output from the wireless signal receiver 112 may be a digital signal input to the programmable logic circuit 130 directly coupled thereto. Alternatively, additional components, such as a rectifier or regulator, may be interposed between the wireless signal receiver 112 and the programmable logic circuit 130. The wireless signal receiver 112 is an example of a means for identifying wireless signal signals.

FIG. 4 illustrates another type of rechargeable computing device with another embodiment remote charging apparatus 460 for implementing the remote reset functionality. The illustrated rechargeable computing device 400 is a hearing aid that includes the remote reset functionality of the rechargeable computing devices described above with reference to FIGS. 1-3 (e.g., 100, 201, 203, and 300). The rechargeable computing device 400 may include the same or similar components to those described above with regard to the rechargeable computing devices 100, 300 (e.g., FIGS. 1 and 3), in addition to components more specific to hearing aids.

Similarly, the remote charging apparatus 460 may include elements similar to the remote charging apparatus 160 described above with reference to FIGS. 1-3. For example, the remote charging apparatus may include a power plug 170 for receiving the AC supply 50, the power transformer 180, the reset input element 190, and the wireless power transmitter 195. In this embodiment, the remote charging apparatus 460 may include a wireless signal transmitter 492 electronically coupled between the power transformer 180 and the wireless power transmitter 195. The wireless signal transmitter 492 may modulate the transformed AC received from the power transformer 180 and use the wireless power transmitter 195 like an antenna to transmit the wireless power transmission 150. The wireless signal transmitter 492 may modulate the transformed AC to achieve a desired transmission characteristic when applied to the wireless power transmitter 195, such as a particular frequency or amplitude. In addition, the wireless signal transmitter 492 may receive input from the reset input element 190. A user pressing the reset button 185 may trigger the reset input element 190 to enhance and/or change the way the wireless signal transmitter 492 modulates the transformed AC current. In particular, in response to receiving the reset input element 190, the wireless signal transmitter 492 may encode the reset signal in the transformed AC current received from the power transformer 180. The encoded reset signal may then be encoded within the wireless power transmission 150 for activating the remote reset functionality in the rechargeable computing device 400.

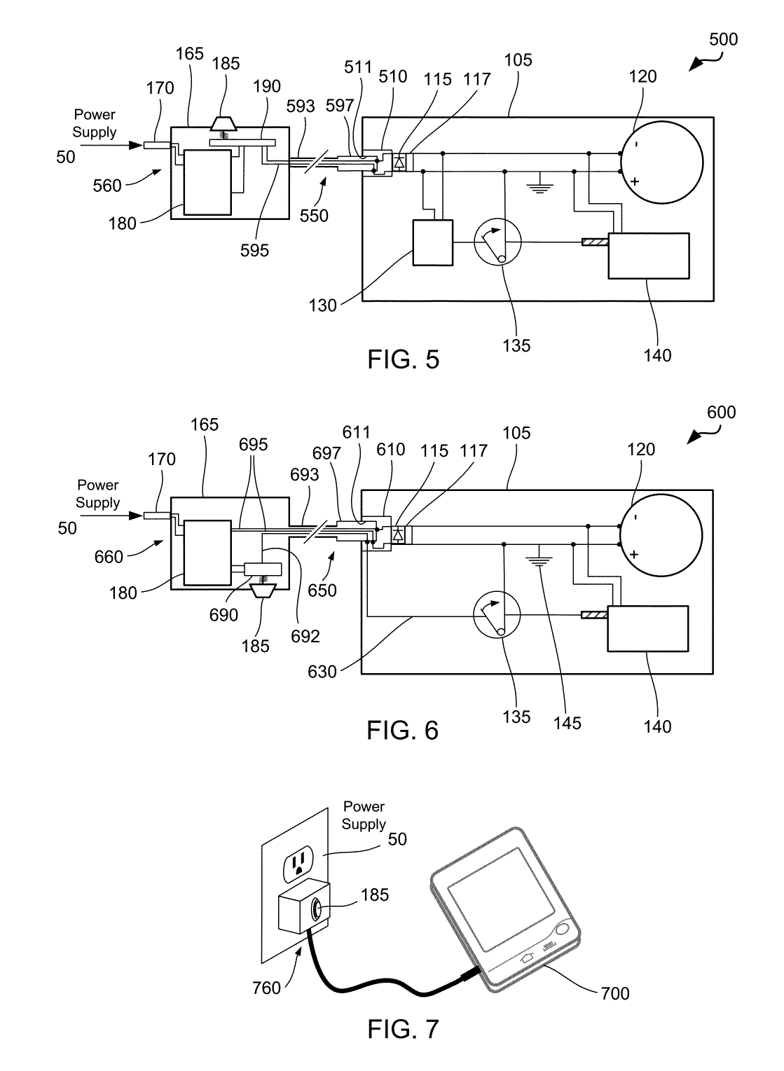

FIG. 5 illustrates another example embodiment rechargeable computing device 500. The rechargeable computing device 500 includes a wired solution that provides the remote reset functionality described above with reference to the rechargeable computing devices of FIGS. 1-4 (i.e., 100, 201, 203, 300, and 400). The rechargeable computing device 500 may be configured to receive a wired power transmission 550 for charging the onboard battery 120 from a remote charging apparatus 560 (i.e., a wired charger) through a wired power transmitter 595. In addition, the remote charging apparatus 560 may be used to transmit a remote reset to the rechargeable computing device 500 by way of the wired power transmission 550. The wired solution refers to the use of a power cord 593 and a first connector 597 forming the wired power transmitter 595.

The wired power transmitter 595 may include a conductive material, such as copper wiring, which conveys the wired power transmission 550, extending continuously between the remote charging apparatus 560 and the rechargeable computing device 500. The wired power transmitter 595 may provide a physical connection formed by a wire in the power cord 593 terminating as first contacts of the first connector 597 (e.g., male connector) received by second contacts of a second connector 511 (e.g., female connector) of a wired power receiver 510 of the rechargeable computing device 500. The first connector 597 is configured to be removably secured to the second connector 511 of the wired power receiver 510. For example, the first connector 597 may snuggly plug into the second connector 511 that includes a recess for receiving the first connector 597. In this way, contacts from the first connector 597 stay engaged to contacts from the second connector 511 for conducting electricity, at least until the power cord 593 is separated from the rechargeable computing device 500. Alternatively, different types of electrical connectors may be employed.

Similar to the rechargeable computing devices described with reference to FIGS. 1-4 (i.e., 100, 201, 203, 300 and 400), the rechargeable computing device 500 may include a housing 105, an onboard battery 120, a programmable logic circuit 130, a reset switch 135, and a processor 140. Also, similar to the remote charging apparatus described with reference to FIGS. 1-4 (i.e., 160, 260, and 460), the remote charging apparatus 560 may include a housing 165 that contains and/or holds various components, including the power plug 170, the power transformer 180, the reset button 185, and the reset input element 190. In this way, the remote charging apparatus 560 may transform the AC supply 50, using the power transformer 180 to step-down the supply voltage, to generate a suitable output power for the rechargeable computing device 500. In addition, the reset input element 190 may include a signal augmentation circuit, such as a modulator, which when activated by the reset button 185 may augment the output power with a reset signal before it is transmitted across the wired power transmitter 595.

Unlike the above embodiments, the output power from the power transformer 180, in the remote charging apparatus 560, need not be converted into electromagnetic waves for wireless transmission. Conductive elements of the wired power transmitter 595 within a power cord 593 of the wired power transmitter 595 may be electronically coupled at a first end to the reset input element 190. The power cord 593 of the wired power transmitter 595 may be virtually any suitable length. In addition, unlike the earlier embodiments, the wired power receiver 510 need not convert the wired power transmission 550, which is already in AC form.

The rechargeable computing device 500 may include the rectifier 115 and/or the regulator 117 coupled between the wired power receiver 510 and other components of the rechargeable computing device 500, such as the onboard battery 120 or the programmable logic circuit 130. Since the wired power receiver 510 conveys the AC from the wired power transmission 550, the rectifier 115 may convert the AC to an onboard DC. The regulator 117 may control the voltage level fed to the onboard battery 120, the processor 140, and other components. The rectifier 115 and/or the regulator 117 may be separate circuit components or integrally formed with the power receiver 110 or other component(s) of the rechargeable computing device 100.

In addition to using the onboard DC from the rectifier 115 to charge directly the onboard battery 120, the reset signal may be detectable therein if included in the wired power transmission 550. Variations in the onboard DC, such as variations in voltage or continuity (i.e., an on/off sequence) therein originating from the wired power transmission 550 may be used to carry a control signal, such as the reset signal. If necessary, additional electronic filters or other components may be included to demodulate and/or isolate the reset signal.

FIG. 6 illustrates another example embodiment rechargeable computing device 600. The rechargeable computing device 600 includes a wired solution with three wires that provides the remote reset functionality described above with reference to the rechargeable computing devices of FIGS. 1-5 (i.e., 100, 201, 203, 300, 400, and 500). The rechargeable computing device 600 may be configured to receive a wired power transmission 650 for charging the onboard battery 120 from a remote charging apparatus 660 (i.e., a wired charger) through a wired power transmitter 695. In addition, the remote charging apparatus 660 may be used to transmit a remote reset to the rechargeable computing device 600 by way of the wired power transmission 650 through a wired signal transmitter 692. The wired solution with three wires refers to the use of a power cord 693 and a first connector 697 containing two (2) wires for the wired power transmitter 695 and a third wire for the wired signal transmitter 692. The electrical energy transmitted across both the wired power transmitter 695 and the wired signal transmitter 692 is referred to collectively herein as the wired power transmission 650.

In contrast to the rechargeable computing devices of FIGS. 1-5 (i.e., 100, 201, 203, 300, 400, and 500), the rechargeable computing device 600 need not include a programmable logic circuit. Instead, the remote charging apparatus 660 may include a reset input element 690 that when triggered by the reset button 185 transmits a reset signal, in the form of an actuation current, through the wired signal transmitter 692 to the reset switch 135, by way of the signal receiving wire 630. The reset input element 690 may range from being a simple switching circuit to a more complex programmable controller for generating and transmitting the reset signal. The reset switch 135 may trigger a reset of the processor 140 when the reset signal is received, thus providing remote reset functionality.

The wired signal transmitter 692 and the wired power transmitter 695 may each include a conductive material, such as copper wiring, which conveys the wired power transmission 650, extending continuously between the remote charging apparatus 660 and the rechargeable computing device 600. The wired signal transmitter 692 and the wired power transmitter 595 may each provide a physical connection formed by the three wires. The first connector 697 is configured to be removably secured to the second connector 611 of the wired power receiver 610. In this way, contacts from the first connector 597 stay engaged to contacts from the second connector 611 for conducting electricity, at least until the power cord 693 is separated from the rechargeable computing device 600. Alternatively, different types of electrical connectors may be employed.

Similar to the rechargeable computing devices described with reference to FIGS. 1-5 (i.e., 100, 201, 203, 300, 400, and 500), the rechargeable computing device 600 may include a housing 105, an onboard battery 120, a reset switch 135, and a processor 140. Also, similar to the remote charging apparatus described with reference to FIGS. 1-5 (i.e., 160, 260, 460, and 560), the remote charging apparatus 660 may include a housing 165 that contains and/or holds various components, including the power plug 170, the power transformer 180, and the reset button 185. In this way, the remote charging apparatus 660 may transform the AC supply 50, using the power transformer 180 to step-down the supply voltage, to generate a suitable output power for the rechargeable computing device 600.

Similar to the wired solution remote charging apparatus described with reference to FIG. 5 (i.e., 560), the output power from the power transformer 180, in the remote charging apparatus 660, need not be converted into electromagnetic waves for wireless transmission. In addition, a wired power receiver 610 of the rechargeable computing device 600 need not convert the wired power transmission 650, which is already in AC form. In addition, the power cord 693 of the wired power transmitter 695 may be virtually any suitable length.

In contrast to the wired solution remote charging apparatus described with reference to FIG. 5 (i.e., 560), the two wires forming the conductive elements of the wired power transmitter 695 within the power cord 693, may be electronically coupled at a first end directly to the power transformer 180. The third wire forming the conductive element of the wired signal transmitter 692, also within the power cord 693, may be electronically coupled at a first end to the reset input element 690. Thus, the wired signal transmitter 692 may separate from the wired power transmitter 695 within the remote charging apparatus 660. A second end of the wired signal transmitter 692 may terminate as an additional contact on the first connector 697. When the first connector 697 is secured in second connector 611, the additional contact of the wired signal transmitter 692 may engage a contact of the signal receiving wire 630 that may be electrically coupled to the processor 140.

While the 3-wire solution may transmit a particular voltage, ground the rechargeable computing device 600, or otherwise convey a reset signal, more than three wires may be included in the wired power transmitter 695. For example, a five-wire solution may convey two voltages, two grounds, and/or a reset signal. In addition, more than three wires may be used to configure the wired power transmitter 695 as a reversible connector.

FIG. 7 illustrates a rechargeable computing device 700 plugged into a remote charging apparatus 760 for remote reset according to various embodiments of the disclosure. The rechargeable computing device 700 is a mobile communication device, such as a cellular telephone. The rechargeable computing device 700 may include one of the wired solutions described with reference to FIGS. 5 and 6 (i.e., a two-wire solution or a three-wire solution). In this way, the remote charging apparatus 760 may transform the AC supply 50 to generate a suitable output power for the rechargeable computing device 700. The remote charging apparatus 760 may include the same or similar components to those described above with regard to either of the remote charging apparatus 560, 660, including the reset button 185. Similarly, the rechargeable computing device 700 may include the same or similar components to those described above with regard to either of the rechargeable computing devices 500, 600.

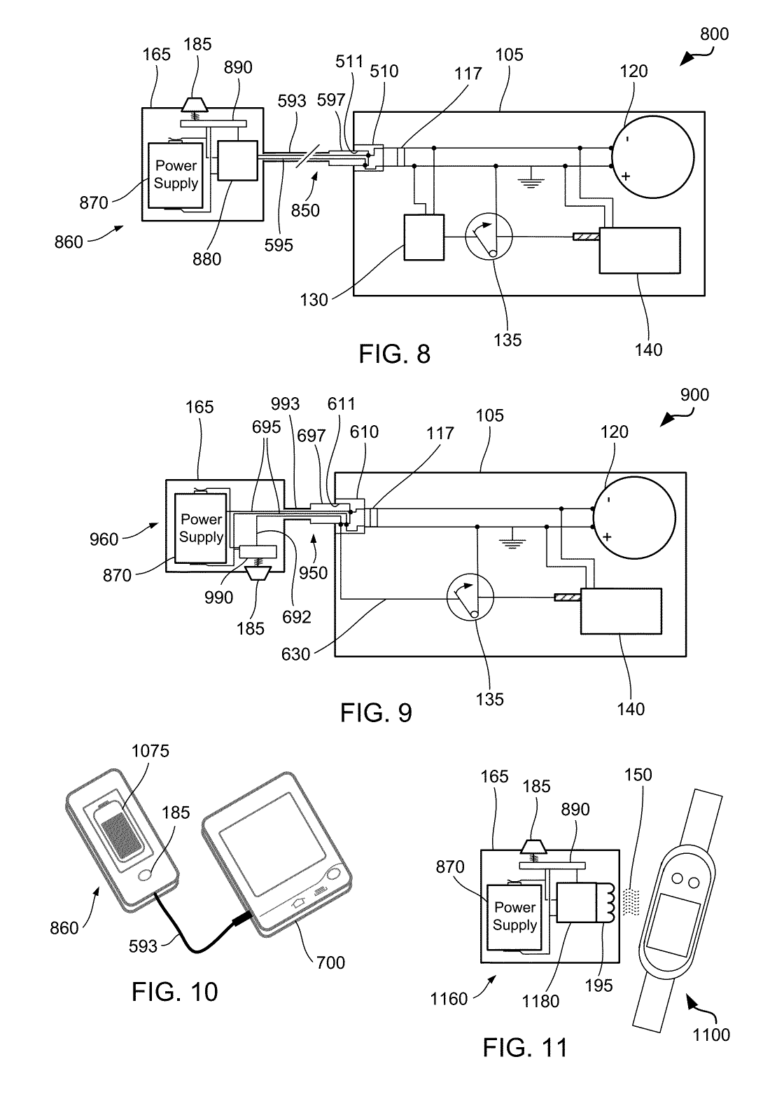

FIG. 8 illustrates another example embodiment rechargeable computing device 800. The rechargeable computing device 800 includes a DC powered wired solution that provides the remote reset functionality described above with reference to the rechargeable computing devices of FIGS. 1-7 (i.e., 100, 201, 203, 300, 400, 500, 600, and 700). The rechargeable computing device 800 may be configured to receive a wired power transmission 850 for charging the onboard battery 120 from a remote charging apparatus 860 (i.e., a DC powered wired charger) through the wired power transmitter 595, including the power cord 593 and the first connector 597 forming the wired power transmitter 595. The wired power transmitter 595, when connected, may extent continuously between the remote charging apparatus 860 and the rechargeable computing device 800. The first connector 597 may be received by second contacts of the second connector 511 of the wired power receiver 510 of the rechargeable computing device 800. In addition, the remote charging apparatus 860 may be used to transmit a remote reset to the rechargeable computing device 800 by way of the wired power transmission 850.

Similar to the rechargeable computing devices described with reference to FIGS. 1-7 (i.e., 100, 201, 203, 300, 400, 500, 600, and 700), the rechargeable computing device 800 may include a housing 105, a onboard battery 120, a programmable logic circuit 130, a reset switch 135, and a processor 140. Also, similar to the remote charging apparatus described with reference to FIGS. 1-7 (i.e., 160, 260, 460, 560, 660, and 760), the remote charging apparatus 860 may include a housing 165 that contains and/or holds various components, including a reset button 185 and a reset input element 890. Unlike the reset input element of FIGS. 1-6 (i.e., 190), the reset input element 890 may operate directly on the provided DC power from a DC power supply 870.

Unlike the wired solution embodiments described with regard to FIGS. 5-7, the remote charging apparatus 860 includes the DC power supply 870 onboard. In this way, the DC power supply 870 may be used to charge the onboard battery 120 without conversion to or from AC. The wired power transmitter 595 may convey the DC power from the remote charging apparatus 860 to the rechargeable computing device 800. Additional circuit components, such as a power regulator 880, may be included to ensure a unidirectional flow of DC power toward the rechargeable computing device 800. When the reset button 185 is depressed, the reset input element 890 may augment the output DC power with a reset signal (e.g., supplying a voltage change, ground, or other reset) that is transmitted across the wired power transmitter 595. In this way, the remote charging apparatus 860 may transform the DC power supply 870, using the power regulator 880 to step-down or otherwise control the supply voltage, to generate a suitable output power for the rechargeable computing device 800.

The rechargeable computing device 800 may include a regulator 117 or surge protection components configured to control the voltage or power level of current conducted to the onboard battery 120, the processor 140, and other components. Once received by the wired power receiver 510, an onboard DC current may charge the onboard battery 120, power other components, or supply the reset signal detectable therein, if included in the wired power transmission 850. Variations in the onboard DC, such as variations in voltage or continuity (i.e., an on/off sequence), originating from the wired power transmission 850 may be used to carry the reset signal. If necessary, additional electronic filters or other components may be included to demodulate and/or isolate the reset signal.

FIG. 9 illustrates another example embodiment rechargeable computing device 900. The rechargeable computing device 900 includes a DC powered wired solution with three wires that provides the remote reset functionality described above with reference to the rechargeable computing devices of FIGS. 1-8 (i.e., 100, 201, 203, 300, 400, 500, 600, 700, and 800). The rechargeable computing device 900 may be configured to receive a wired power transmission 950 for charging the onboard battery 120 from a remote charging apparatus 960 (i.e., a DC powered wired charger) through the wired power transmitter 695. In addition, the remote charging apparatus 960 may be used to transmit a remote reset to the rechargeable computing device 900 by way of the wired power transmission 950 through the wired signal transmitter 692.

Similar to the rechargeable computing devices described with reference to FIGS. 1-8 (i.e., 100, 201, 203, 300, 400, 500, 600, 700, and 800), the rechargeable computing device 900 may include a signal receiving wire 630 that is configured to receive a reset signal from the remote charging apparatus 960.

The remote charging apparatus 960 may include a rigid extender 993, rather than the flexible power cord included with reference to the remote charging apparatus of FIG. 5-8 (e.g., 593, 693). The rigid extender 993 may be configured to fixedly connect the rechargeable computing device 900 in close proximity to the remote charging apparatus 960. The rigid extender 993 may contain the wired signal transmitter 692 and the wired power transmitter 695 for conveying the wired power transmission 950. In addition, the first connector 697 may be configured to be removably secured to the second connector 611 of the wired power receiver 610. The rigid extender 993 may be used as an alternative to the flexible power cords of the embodiments described with reference to FIG. 5-8 (e.g., 593, 693). The dimensions of the rigid extender 993 may be varied.

Similar to the rechargeable computing device of FIG. 6 (i.e., 600), the rechargeable computing device 900 need not include a programmable logic circuit. Instead, the remote charging apparatus 960 may include a reset input element 990 that, when triggered by the reset button 185, transmits a reset signal in the form of an actuation current through the wired signal transmitter 692 to the reset switch 135 by way of the signal receiving wire 630. The reset switch 135 may trigger a reset of the processor 140 when the reset signal is received, thus providing remote reset functionality. The reset input element 990 may range from being a simple switching circuit to a more complex programmable controller for generating and transmitting the reset signal. In addition, unlike the reset input element of FIG. 6 (i.e., 690), the reset input element 990 may operate directly on the provided DC power from the DC power supply 870.

Also similar to the remote charging apparatus described with reference to FIG. 8 (i.e., 860), the remote charging apparatus 960 may include a housing 165 that contains and/or holds various components, including the reset button 185 and the DC power supply 870. In addition, the DC power supply 870 may be used to charge the onboard battery 120 without conversion to or from AC.

FIG. 10 illustrates the rechargeable computing device 700 plugged into the remote charging apparatus 860 for remote reset according to various embodiments of the disclosure. The rechargeable computing device 700 may include one of the DC powered wired solutions described with reference to FIGS. 8 and 9 (i.e., the two or more wire solutions). In this way, the remote charging apparatus 860 may provide a DC power supply to generate a suitable output power for the rechargeable computing device 700. The remote charging apparatus 760 may include the same or similar components to those described above with regard to either remote charging apparatus described with reference to FIG. 8 (i.e., 860), including the reset button 185 and the power cord 593. In addition, the remote charging apparatus 760 may include a visual power level indicator 1075 to indicate how much power it holds for charging the rechargeable computing device 700. The remote charging apparatus 760 may itself be a rechargeable power storage device. Similarly, the rechargeable computing device 700 may include the same or similar components to those described above with regard to either of the rechargeable computing devices described with reference to FIGS. 8 and 9 (i.e., 800, 900).

FIG. 11 illustrates another type of rechargeable computing device 1100 with another embodiment DC powered, remote charging apparatus 1160 for implementing the remote reset functionality. The illustrated rechargeable computing device 1100 is a body-worn biometric monitoring device, such as a heart rate or respiration monitor, which includes the remote reset functionality of the rechargeable computing devices described above with reference to FIGS. 1-10 (i.e., 100, 201, 203, 300, 400, 500, 600, 700, 800, and 900). The rechargeable computing device 1100 may include the same or similar components as those of the wirelessly charged rechargeable computing devices described above with reference to FIGS. 1-4 (i.e., 100, 201, 203, 300, and 400), in addition to components more specific to a biometric monitoring device.

In contrast to DC powered rechargeable computing devices of FIGS. 8-10 (i.e., 700, 800, and 900), the remote charging apparatus 1160 may include a DC power supply 870 that may be converted to AC power before generating the wireless power transmission 150. The remote charging apparatus 1160 may included a power converter 1180 (i.e., converting DC-to-AC) configured to convert the power received from the DC power supply 870 to an AC current with a frequency suitable for wireless power transmission, which is applied to the wireless power transmitter 195. Similar to the remote charging apparatus described with reference to FIG. 8 (i.e., 860), the remote charging apparatus 1160 may include the housing 165 that contains and/or holds various components, including a reset button 185 and the reset input element 890. When a user engages the reset button 185, the reset input element 890 may augment the AC wireless power transmissions with a reset signal encoded within one or more of frequency, amplitude, and continuity (i.e., on or off signaling) as it is transmitted by the wireless power transmitter 195.

In various embodiments, the remote reset functionality may create security issues for the rechargeable computing devices (e.g., 100, 201, 203, 300, 400, 500, 600, and 700) without providing security protections. For example, without security protections an unauthorized third party may reset the processor of a rechargeable computing device. Similarly, without security protections a user may inadvertently reset the processor of the rechargeable computing device. Thus, security protections may be added, such as requiring a unique RFID tag or other key device be used with either the rechargeable computing device or the remote charging apparatus, to prevent unauthorized third-party kills or inadvertent resets. Similarly, the reset button (i.e., 185) may be replaced with a keypad of a key-code entry module. In this way, only an authorized user may enter a secure reset code in the keypad to reset the rechargeable computing device.

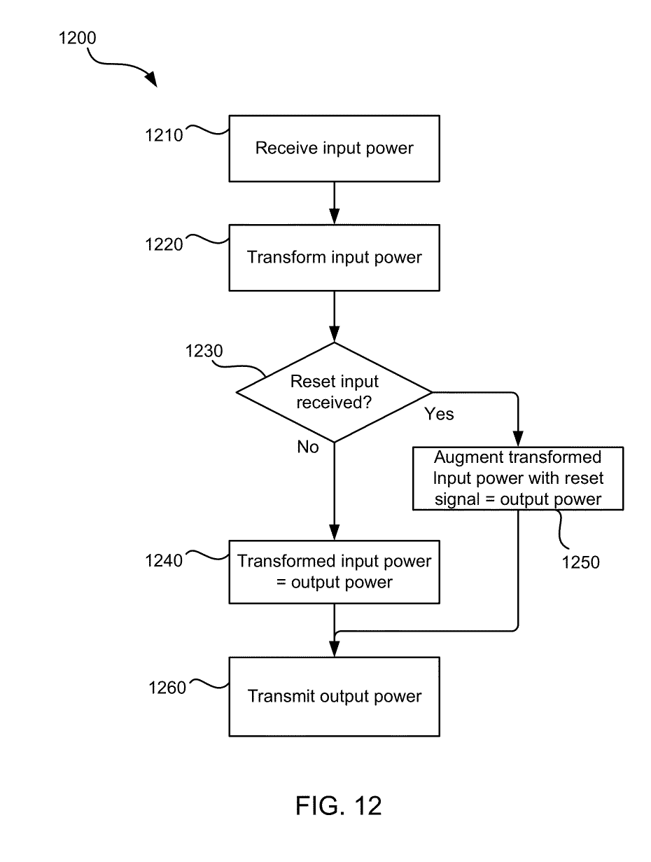

FIG. 12 illustrates an embodiment method 1200 of charging a rechargeable computing device, with remote reset functionality, in accordance with various embodiments. The method 1200 may be performed using a remote charging apparatus handling AC power, similar to those described at least with reference to FIGS. 1-7 and 11 (i.e., 160, 260, 460, 560, 660, 760, and 1160). In block 1210, input power may be received from a power supply. For example, conductive prongs (e.g., 170 in FIGS. 1 and 3-6) of a remote charging apparatus may receive the input power from an AC power supply, such as a wall receptacle (e.g., 50 in FIGS. 1-7). As another example, DC power may be received internally within the remote charging apparatus, such as at a power converter (e.g., 1180 in FIG. 11) from the DC power supply (e.g., 870 in FIG. 11). In block 1220, the input power may be transformed, such as using a power transformer or power converter (e.g., 180 in FIGS. 1 and 3-6; or 1180 in FIG. 11). In determination block 1230, a circuit component (e.g., 190 in FIG. 1-6; or 890 in FIG. 11) may determine whether a reset input was received. The reset input may be received from a user pressing a reset button (e.g., 185 in FIGS. 1-7 and 11). In response to determining that no reset input was received (i.e., determination block 1230=“No”), in block 1240 the transformed input power will equal an output power of the remote charging apparatus. In response to determining that a reset input was received (i.e., determination block 1230=“Yes”), the transformed input power may be augmented with a reset signal forming the output power in block 1250. In this way, the output power in block 1250 may include the reset signal in-band within the output power. In block 1260, the output power may be transmitted from the remote charging apparatus to the rechargeable computing device in accordance with various embodiments.

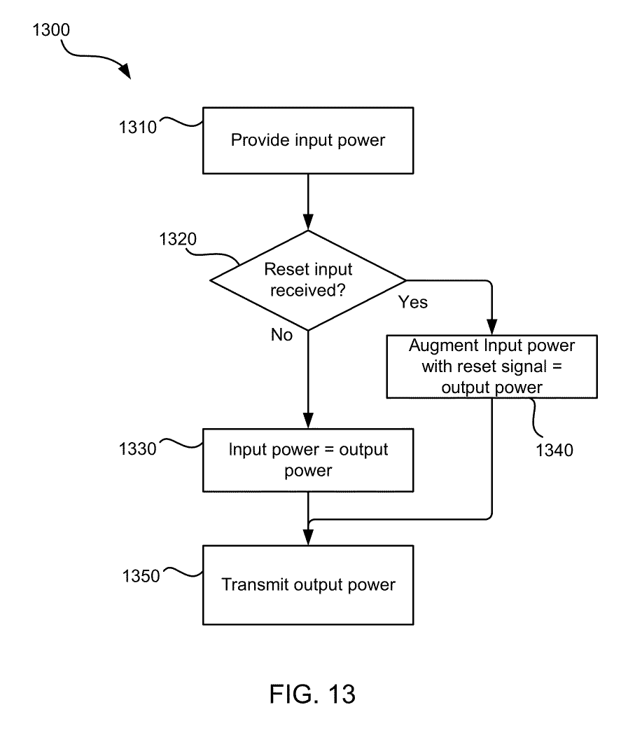

FIG. 13 illustrates an embodiment method 1300 of charging a rechargeable computing device, with remote reset functionality, in accordance with various embodiments. The method 1300 may be performed using a remote charging apparatus handling only DC power, similar to those described with reference to FIGS. 8-10 (i.e., 860 and 960). In block 1310, input power may be provided from a power supply (e.g., 870 in FIGS. 8 and 9). In determination block 1320, a circuit component (e.g., 890, 990 in FIGS. 8 and 9) may determine whether a reset input was received. The reset input may be received from a user pressing a reset button (e.g., 185 in FIGS. 8 and 9). In response to determining that no reset input was received (i.e., determination block 1320=“No”), the input power will equal an output power of the remote charging apparatus in block 1330.

In response to determining that a reset input was received (i.e., determination block 1320=“Yes”), the input power may be augmented with a reset signal forming the output power in block 1340. For example, in a two-wire solution using a DC power supply similar to that described with reference to FIG. 8, the output power in block 1340 may include the reset signal in-band within the output power. As another example, in the three-wire solution using a DC power supply similar to that described with reference to FIG. 9, the output power in block 1340 may include the reset signal conveyed using the third wire, which the charging power is conveyed using the two other wires. In block 1350, the output power may be transmitted from the remote charging apparatus to the rechargeable computing device in accordance with various embodiments.

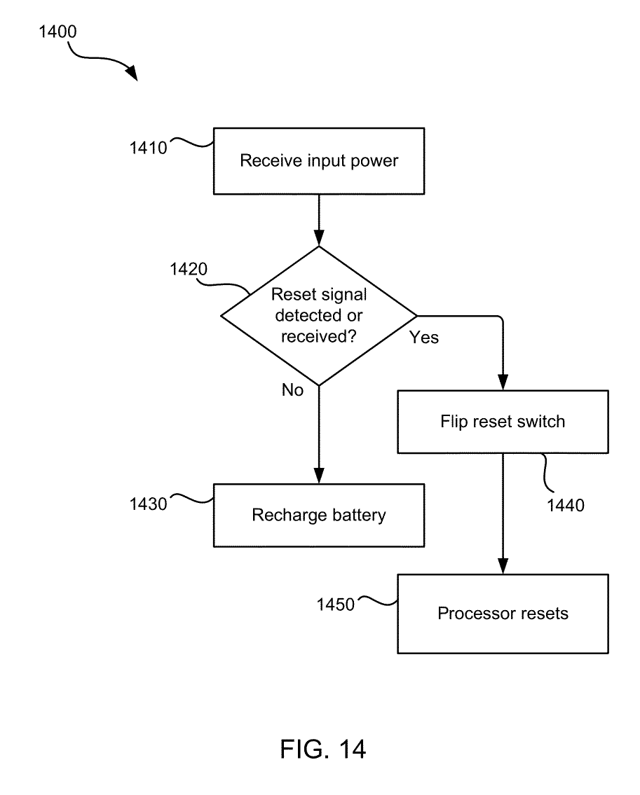

FIG. 14 illustrates an embodiment method 1400 of charging a rechargeable computing device having remote reset functionality in accordance with various embodiments. The method 1400 may be performed using a rechargeable computing device similar to those described with reference to FIGS. 1-11 (i.e., 100, 201, 203, 300, 400, 500, 600, 700, 800, and 900). In block 1410, input power may be received from a remote charging device similar to those described with reference to FIGS. 1-11 (i.e., 160, 280, 460, 560, 660, 760, 860, 960, and 1160). In determination block 1420, a programmable logic circuit similar to those described with reference to FIGS. 1, 3, 5, and 8 (i.e., 130) may determine whether a reset signal is detected in-band within the received input power. In response to determining that no reset signal is detected (i.e., determination block 1420=“No”), in block 1430 an onboard battery (e.g., 120 in FIGS. 1, 3, 5, 8 and 9) of the rechargeable computing device may receive a charge in a conventional sense. In response to determining that the reset signal is detected (i.e., determination block 1420=“Yes”), an onboard reset switch (e.g., 135 in FIGS. 1, 3, 5, 8 and 9) may be activated (i.e., opened/closed) in block 1440. In block 1450, activating the reset switch may trigger a processor (e.g., 140 in FIGS. 1, 3, 5, 8 and 9) of the rechargeable computing device to reset in accordance with various embodiments.

Some embodiments may include a method of charging a rechargeable computing device that includes receiving an input power from a remote charging apparatus by a power receiver of the rechargeable computing device. The method may also include determining (e.g., via a programmable logic circuit of the rechargeable computing device) whether a reset signal is detected in-band within the received input power. The method may include activating an onboard reset switch of the remote charging apparatus in response to detecting the reset signal within the received input power. In some embodiments, the onboard reset switch may couple a reset input pin of the processor to ground or a voltage source (e.g., the battery). Typically, processors perform a reset or full reboot when their reset pin is activated with a voltage (or when voltage is removed from the pin).

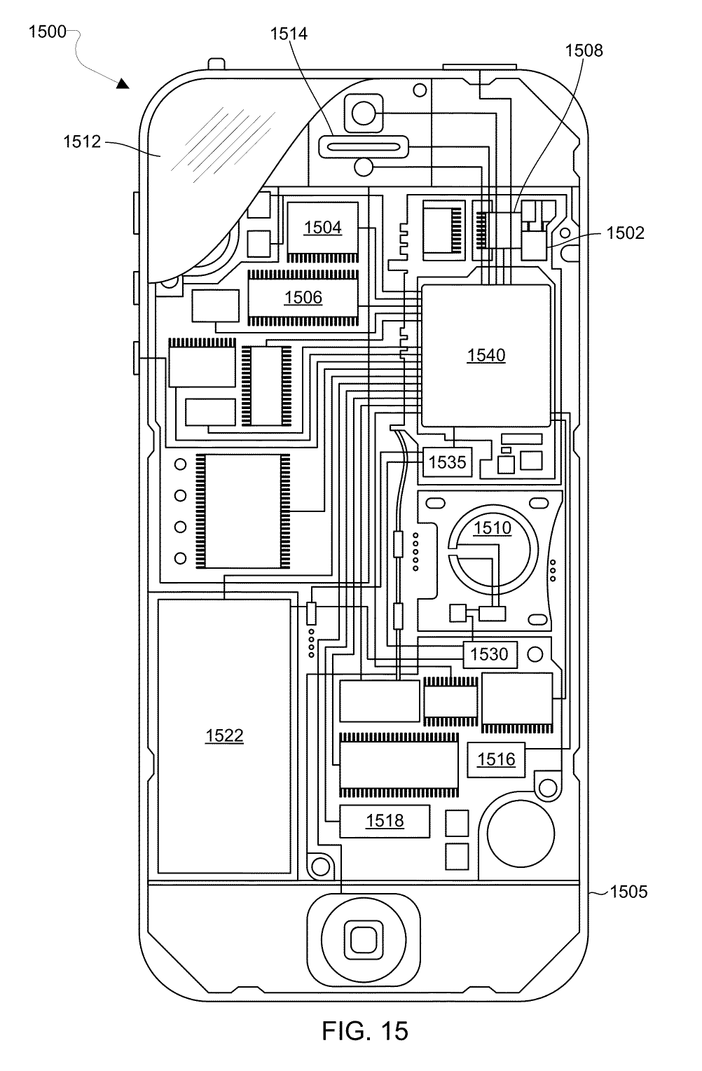

The various embodiments (including, but not limited to, embodiments described above with reference to FIGS. 1-14) may be implemented in and/or with any of a variety of rechargeable computing devices, an example of which is illustrated in FIG. 15 in the form of a cellular telephone. In this way, the rechargeable computing device in various embodiments may be a rechargeable computing device as illustrated in FIG. 15 and as described below. In various embodiments, the rechargeable computing device 1500 may include a power receiver 1510, a programmable logic circuit 1530, a reset switch 1535, and a processor 1540. In addition, in various embodiments the processor 1540 of the rechargeable computing device 1500 may be coupled to a touch-screen controller 1504 and an internal memory 1506. The processor 1540 may be one or more multicore ICs designated for general or specific processing tasks. The internal memory 1506 may be volatile or non-volatile memory such as NAND, and may be secure and/or encrypted memory, or unsecure and/or unencrypted memory, or any combination thereof. The processor 1540 may be coupled to a touch-screen controller 1504. The touch-screen controller 1504 and the processor 1540 may also be coupled to a touch-screen panel 1512, such as a resistive-sensing touch-screen, capacitive-sensing touch-screen, infrared sensing touch-screen, etc. Alternatively, the various embodiments may be implemented in and/or with any of a variety of devices that do not include a touch-screen controller, touch-screen or any form of screen or direct data interface, such as a data card, wireless hotspot device, network component, peripheral memory device or similar “headless” devices. The rechargeable computing device 1500 may have at least one radio signal transceiver 1508 (e.g., Peanut®, Bluetooth®, Zigbee®, Wi-Fi, RF radio) and antennae 1502, for sending and receiving, coupled to each other and/or to the processor 1540. The radio signal transceiver 1508 and antennae 1502 may be used with the above-mentioned circuitry to implement the various wireless transmission protocol stacks and interfaces. The rechargeable computing device 1500 may include a cellular network wireless modem chip 1516 coupled to the processor that enables communication via a cellular network. The rechargeable computing device 1500 may include a peripheral device connection interface 1518 coupled to the processor 1540. The peripheral device connection interface 1518 may be singularly configured to accept one type of connection, or multiply configured to accept various types of physical and communication connections, common or proprietary, such as USB, FireWire, Thunderbolt, or PCIe. The peripheral device connection interface 1518 may also be coupled to a similarly configured peripheral device connection port (not shown). The rechargeable computing device 1500 may also include speakers 1514 for providing audio outputs. The rechargeable computing device 1500 may also include a casing 1505, constructed of a plastic, metal, or a combination of materials, for containing all or some of the components discussed herein. The rechargeable computing device 1500 may include an onboard battery 1522 coupled to the processor 1540, such as a battery with power disconnect in accordance with various embodiments herein. The onboard battery 1522 may also be coupled to the peripheral device connection port to receive a charging current from a source external to the rechargeable computing device 1500.

The processors in the various embodiments described herein, including the programmable logic circuit, may be any programmable microprocessor, microcomputer or multiple processor chip or chips that can be configured by instructions (i.e., software instructions, such as applications) to perform a variety of functions, including the functions of the various embodiments described above. In some devices, multiple processors may be provided, such as one processor dedicated to wireless communication functions and one processor dedicated to running other applications. Typically, before being accessed and loaded into the processors, software applications may be stored in the internal memory. The processors may include internal memory sufficient to store the application instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processor themselves.

The foregoing method descriptions and the process and communication flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the,” is not to be construed as limiting the element to the singular.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, processor, or state machine. A processor may also be implemented as a combination of rechargeable computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor medium. The operations of a method or algorithm disclosed herein may be embodied in a processor-executable software module that may be stored on a non-transitory processor storage medium. Non-transitory processor storage media may be any available media that may be accessed by a processor. By way of example, and not limitation, such non-transitory processor media may comprise RAM, ROM, EEPROM, CD-ROM or other optical disk storage, magnetic disk storage or other magnetic storage devices, or any other medium that may be used to store desired processor executable code in the form of instructions or data structures and that may be accessed by a processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory processor media. Additionally, the operations of a method or algorithm may reside as one or any combination or set of codes and/or instructions on a non-transitory machine-readable medium and/or processor medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the aspects shown herein but is to be accorded the widest scope consistent with the following claims and the principles and novel features disclosed herein.

What is claimed is:

1. A rechargeable computing device, comprising:
a battery;
a processor configured to control operations of the rechargeable computing device, wherein the processor is powered by the battery;
a power receiver coupled to the battery and configured to receive a wireless power transmission from a remote charging apparatus and charge the battery using power captured from the wireless power transmission;
a reset switch coupled to the processor; and
a programmable logic circuit coupled to the power receiver and the reset switch, wherein the programmable logic circuit is configured to activate the reset switch to reset the processor in response to detecting a reset signal encoded within the wireless power transmission.

2. The rechargeable computing device of claim 1, further comprising:
a wireless signal receiver coupling the power receiver to the programmable logic circuit, wherein the wireless signal receiver is configured to detect the reset signal using amplitude modulation of the wireless power transmission.

3. The rechargeable computing device of claim 1, further comprising:
a wireless signal receiver coupling the power receiver to the programmable logic circuit, wherein the wireless signal receiver is configured to detect the reset signal using frequency modulation of the wireless power transmission.

4. The rechargeable computing device of claim 1, wherein the programmable logic circuit is configured to recognize the reset signal as a coded sequence in the wireless power transmission.

5. The rechargeable computing device of claim 1, wherein the programmable logic circuit is configured to operate independent of the processor.

6. The rechargeable computing device of claim 1, wherein the programmable logic circuit is independently powered by the battery.

7. A system, comprising:
a remote charging apparatus comprising:
a charger housing;
a power transmitter disposed within the charger housing, the power transmitter configured to receive a power input from a power source and output a wireless power transmission; and
a reset input element connected to the power transmitter and configured to encode a reset signal in the wireless power transmission in response to receiving a user input; and
a rechargeable computing device, comprising:
a battery;
a processor configured to control operations of the rechargeable computing device, wherein the processor is powered by the battery;
a power receiver coupled to the battery and configured to receive the wireless power transmission from the remote charging apparatus and charge the battery using power captured from the wireless power transmission;
a reset switch coupled to the processor; and
a programmable logic circuit coupled to the power receiver and the reset switch, wherein the programmable logic circuit is configured to activate the reset switch to reset the processor in response to detecting the reset signal encoded within the wireless power transmission.

8. The system of claim 7, wherein the remote charging apparatus further comprises a wireless signal transmitter configured to encode the reset signal in the wireless power transmission.

9. The system of claim 7, wherein the remote charging apparatus further comprises a power plug configured to receive the power input from the power source, wherein the power plug is connected and conveys the power input to the power transmitter.

10. The system of claim 7, wherein the remote charging apparatus further comprises a DC power supply, wherein the power supply providing the power input includes the DC power supply.

11. The system of claim 10, wherein the remote charging apparatus further comprises a power converter for transforming a DC current from the DC power supply into an AC current, wherein the power converter is coupled to the DC power supply and the power transmitter.

12. A rechargeable computing device, comprising:
a rechargeable battery;
means for controlling operations of the rechargeable computing device, wherein the means for controlling operations is powered by the rechargeable battery;
means for receiving power coupled to the rechargeable battery and configured to receive a wireless power transmission from a remote charging apparatus and charge the rechargeable battery using power captured from the wireless power transmission;
means for resetting the means for controlling operations coupled to the means for controlling operations; and
means for detecting a reset signal encoded within the wireless power transmission and activate the means for resetting the means for controlling operations in response to detecting the reset signal.

13. The rechargeable computing device of claim 12, further comprising means for identifying wireless signals coupling the means for receiving power to the means for detecting the reset signal encoded within the wireless power transmission, wherein means for identifying wireless signals comprises means for detecting the reset signal using amplitude modulation of the wireless power transmission.

14. The rechargeable computing device of claim 12, further comprising means for identifying wireless signals coupling the means for receiving power to the means for detecting the reset signal encoded within the wireless power transmission, wherein means for identifying wireless signals comprises means for detecting the reset signal using frequency modulation of the wireless power transmission.

15. The rechargeable computing device of claim 12, wherein means for detecting the reset signal encoded within the wireless power transmission comprises means for detecting the reset signal encoded within the wireless power transmission as a coded sequence in the wireless power transmission.

16. The rechargeable computing device of claim 12, wherein means for detecting the reset signal encoded within the wireless power transmission comprises means for detecting the reset signal encoded within the wireless power transmission independent of the means for controlling operations of the rechargeable computing device.

17. The rechargeable computing device of claim 12, wherein means for detecting the reset signal encoded within the wireless power transmission is independently powered by the rechargeable battery.
